(19) United States
(12) Patent Application Publication
(10) Pub. No.: US 2006/0019645 A1
(43) Pub. Date: Jan. 26, 2006

(54) Enforcement of permitted cell phone usage

(76) Inventors: Kouros Azimi, Center Valley, PA (US); John Michejda, Berkeley Heights, NJ (US); H. Scott Fetterman, New Tripoli, PA (US)

Correspondence Address: MANELLI DENISON & SELTER PLLC;7th Floor, 2000 M Street, N.W., Washington, DC, 20036-3307, US

(21) Appl. No.: 10/893,986

(22) Filed: Jul. 20, 2004

(51) Int. Cl. H04K 3/00; H04M 3/00

(52) U.S. Cl. 455/419; 455/431; 455/572

(57) ABSTRACT

A set of usage rules are implemented to disable particular features of a wireless device (e.g., audible ringing, use of camera, etc.), or to forcibly power down the device, based upon it's presence in an area with restricted usage rules. A number of BLUETOOTH™ enabled or other suitably enabled devices such as a cell phones, personal digital assistant (PDA), pager, and email device such as a BLACKBERRY™ or SMARTPHONE™ device, may be automatically instructed to enact one or more rules provided by a Rules Enforcer Transceiver. A “Rules Enabled” cell phone or other wireless device thus may be taken into sensitive areas such as hospitals, movie theatres, etc. For instance, audible ringing may be disabled (or, alternatively, silent ringing such as vibration may be forcibly enabled.) Similarly, camera functionality may be disabled when entering given establishments that prohibit use of such devices, e.g., health clubs, spas, or corporate offices to prevent industrial espionage, etc.

### BACKGROUND OF THE INVENTION

1. Field of the Invention

The present invention relates to the use of cell phones and/or other BLUETOOTH™ enabled devices within establishments, vehicles and locations that have rules about the use of such devices.

2. Background of Related Art

No one can dispute the usefulness and convenience of wireless telephones (i.e., cell phones). They have become an everyday convenience for many people, and are often carried around with a person as they move about throughout the day.

With the proliferation of cellular telephones, especially cell phone models which incorporate cameras, there are growing concerns about appropriate usage. For instance, cameras raise an issue about invasion of privacy due to indiscrete use of the camera to take pictures in inappropriate places. Other concerns relate to public annoyances caused by cell phones ringing. Besides social issues, safety issues have been raised by the use of cell phones in certain limited circumstances, e.g., while in an airplane or in a hospital.

For instance, in the United States federal regulations have been enacted that require people with cell phones to turn them off while in an airborne airplane, as it has been determined that cell phone usage may interfere with the operation of the airplane and/or its communications. Passengers comply with such regulations, but may nevertheless inadvertently forget to turn a cell phone off, or even forget that an active cell phone is in their purse, etc. There are currently no devices in airplanes to sniff out and identify cell phones that remain turned on during flight to ensure compliance with the regulations.

In an attempt to dispel some fears of innocent bystanders, many establishments have posted rules regarding usage of such cellular telephones. For instance, many health clubs and spas do not permit use of wireless devices with cameras. To enforce such rules, health clubs often have a large, prominent sign placed in an entranceway to alert and remind users that they are not permitted to use cell phones with a camera while on the premises, or for that matter a camera at all. There are rarely officials in such establishments that monitor prohibited use of wireless devices, much less officials with the authority or capacity to stop unauthorized usage once discovered. So, non-usage of such camera-capable cell phones and other devices is largely voluntary, based on the honor system, and hopefully adhered to.

There is a need for an improved technique to easily and reliably prevent unauthorized usage modes of wireless devices in given establishments, locales, vehicles, etc.

### SUMMARY OF THE INVENTION

In accordance with the principles of the present invention, a communications protocol for enforcing usage rules of a wireless device comprises establishing at least one rule relating to an action to be forcibly applied to a wireless device. At least one rule is wirelessly transmitted to the wireless device when the wireless device enters a physical area to which the usage rule applies. The at least one rule relates to an operational parameter of the wireless device without allowing a user of the wireless device to override the at least one rule.

A method of implementing a mandatory usage rule for operation of a wireless device in accordance with another aspect of the present invention comprises establishing a wireless link to receive at least one rule relating to operation of at least one feature of the wireless device when the wireless device enters a physical area to which the usage rule applies. An instruction contained by the at least one rule in the wireless device is automatically implemented. The at least one rule relates to an operational parameter of the wireless device without allowing a user of the wireless device to override the at least one rule.

### BRIEF DESCRIPTION OF THE DRAWINGS

Features and advantages of the present invention will become apparent to those skilled in the art from the following description with reference to the drawings, in which:

FIG. 1 shows a number of BLUETOOTH™ enabled devices such as a cell phones, personal digital assistant (PDA), pager, and email device such as a BLACKBERRY™ or SMARTPHONE™ device, automatically controlled into enacting one or more rules provided by a Rules Enforcer Transceiver, in accordance with the principles of the present invention.

FIG. 2A exemplifies a table of rules that may be maintained in the rules enforcer transceiver, in accordance with the principles of the present invention.

FIG. 2B shows that any one type device may have multiple rules applied, and those rules may be simple, or may be detailed and complex, in accordance with the principles of the present invention.

FIG. 3 shows relevant portions of a BLUETOOTH™ enabled phone and a Rules Enforcer Transceiver, shown in FIG. 1.

FIG. 4 shows an exemplary flow diagram of a Rules Enforcer Transceiver providing rules information to a BLUETOOTH™ enabled device such as a phone, PDA, etc., in accordance with the principles of the present invention.

FIG. 5 shows an exemplary flow diagram of a BLUETOOTH™ enabled device having a mode forcibly changed due to reception of an appropriate rule from a Rules Enforcer Transceiver, in accordance with the principles of the present invention.

FIG. 6 shows an exemplary flow diagram of a BLUETOOTH™ enabled device being forcibly powered down due to reception of an appropriate rule from a Rules Enforcer Transceiver, in accordance with the principles of the present invention.

### DETAILED DESCRIPTION OF ILLUSTRATIVE EMBODIMENTS

The present invention incorporates a set of usage rules that operates in conjunction with hardware which disables particular features of a wireless device (e.g., audible ringing, use of camera, etc.), or which forcibly powers down or otherwise disables an electronic device, based upon the presence of the electronic device in an area with restricted use rules. Thus, enablement of relevant features of a wireless device (e.g., cell phone) is restricted based on the presence of the wireless device in a predefined location.

In accordance with the principles of the present invention, a “Rules Enabled” cell phone or other wireless device may be safely taken into sensitive areas such as hospitals, movie theatres, etc. In locations where audible ringing is an annoyance, the cell phone configuration will be automatically affected. For instance, audible ringing may be disabled (or, alternatively, silent ringing such as vibration may be forcibly enabled.) Similarly, camera functionality may be disabled when entering given establishments that prohibit use of such devices, e.g., health clubs, spas, or corporate offices to prevent industrial espionage, etc.

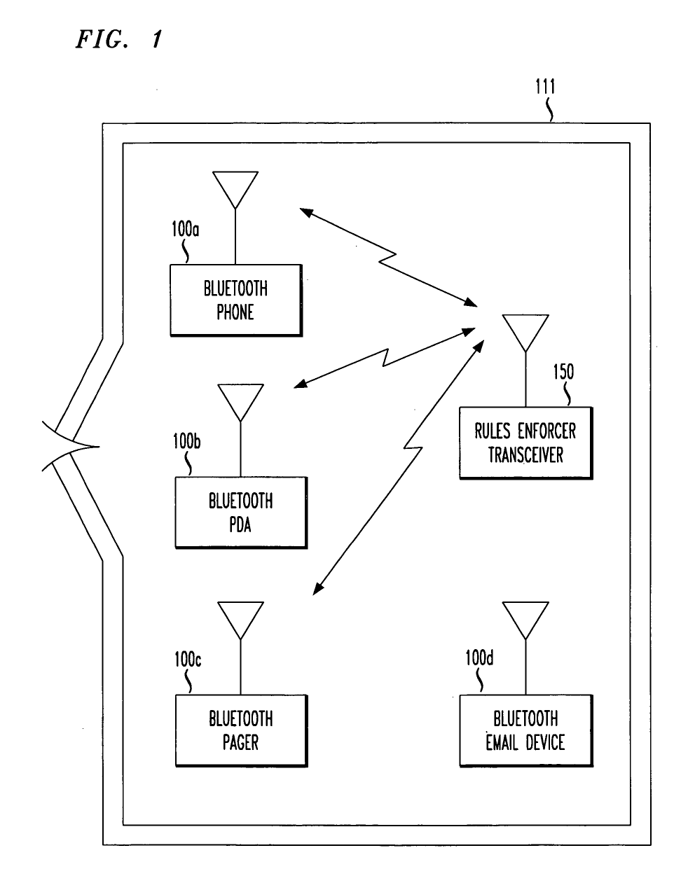

FIG. 1 shows a number of BLUETOOTH™ enabled devices such as a cell phones, personal digital assistant (PDA), pager, and email device such as a BLACKBERRY™ or SMARTPHONE™ device, automatically controlled into enacting one or more rules provided by a Rules Enforcer Transceiver, in accordance with the principles of the present invention.

In particular, as shown in FIG. 1, various wireless devices, in particularly piconet devices conforming to a BLUETOOTH™ standard, enter a premises 111 (e.g., a hospital, airplane, etc.), and establish communications with a rules enforcer transceiver 150.

In operation, an appropriate transmitted device, referred to herein as a ‘rules transmitter’ or ‘rules enforcer transceiver’ 150, is placed near entrances and/or exits and throughout a given establishment to be protected by such rules. This allows and dis-allows relevant handset features of the cell phone based on the particular site and location within a site, and on a user specific basis.

Such ‘rules’ transmitter 150 may be based on RF, BLUETOOTH™, infrared, etc. technologies depending upon the region to cover. As such, the relevant wireless devices are equipped with an appropriate matching receiver also based on RF, BLUETOOTH™, infrared, etc. technologies.

In the given example, the rules enforcer transceiver 150 acts as a master, and each of the wireless communications devices 100a-100d establish a piconet network virtual link with the rules enforcer transceiver 150.

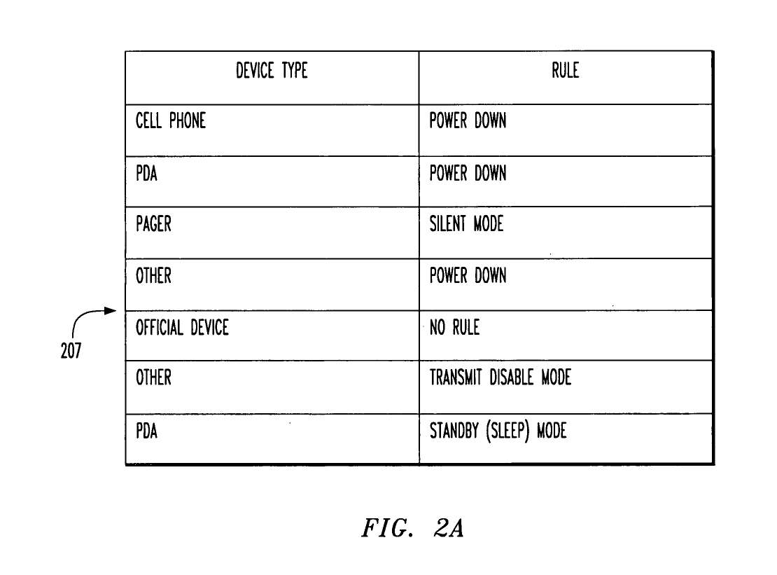

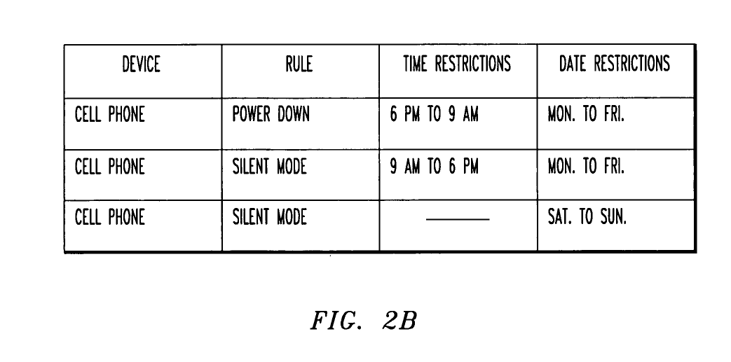

FIG. 2A exemplifies a table of rules 207 that may be maintained in the rules enforcer transceiver 150, in accordance with the principles of the present invention. While the particular table used may take any form and/or contain any rules, such rules are restrictive to the devices to which they are associated.

For instance, a rule to “power down” may be associated with cell phones that come into the network including the rules enforcer transceiver 150, as shown by the first entry in the table 207.

In an exemplary second entry in the table 207 shown in FIG. 2A, all personal digital assistants (PDAs) have a rule applied which instructs them to forcibly, automatically power down if they are powered up to receive the rule. Of course, devices which are already powered down need not have a rule received and/or applied.

All devices of a type may be affected, or qualifications may be applied. For instance, all cell phones may be instructed to power down with a single rule. Alternatively, only cell phones including a camera may be instructed to power down, while cell phones without a camera may be permitted to continue operating, i.e., have no rule applied to them.

In a third entry of table 207, pagers have a rule which forcibly causes them to enter a silent mode (e.g., no audible beeping, just vibration).

In a fourth entry, ‘other devices’, i.e., devices which are not otherwise represented in the table 207, are instructed to power down.

In a fifth entry of table 207, qualifications may be applied to any/all devices. For instance, devices which carry identifications associated with state or government officials (e.g., police, military, fire department, etc.) may also receive a rule that cancels any other rule. Thus, it is possible that some rules may trump other rules.

FIG. 2B shows that any one type device may have multiple rules applied, and those rules may be simple, or may be detailed and complex. Multiple rules are preferably compiled by the rules enforcer transceiver 150 before transmission to the wireless devices 100a-100d, but may be transmitted individually and assimilated by the individual wireless devices 100a-100d.

As exemplified in FIG. 2B, time and/or date information may be included with any particular rule. For instance, time and/or date restrictive rules may be applied to any of the rules. As an example, perhaps in a hospital environment cell phone usage may be restricted only during evening hours, in which case a power down rule may be communicated from the rules enforcer transceiver 150 to the BLUETOOTH™ enabled phone 100a only during evening hours.

Rules from the rules enforcer transceiver 150 are mandatory to the relevant wireless phones 100a-100d, and thus can be considered to ‘forcibly’ cause the desired action, be it power down, change of mode, disablement of a particular feature, etc.

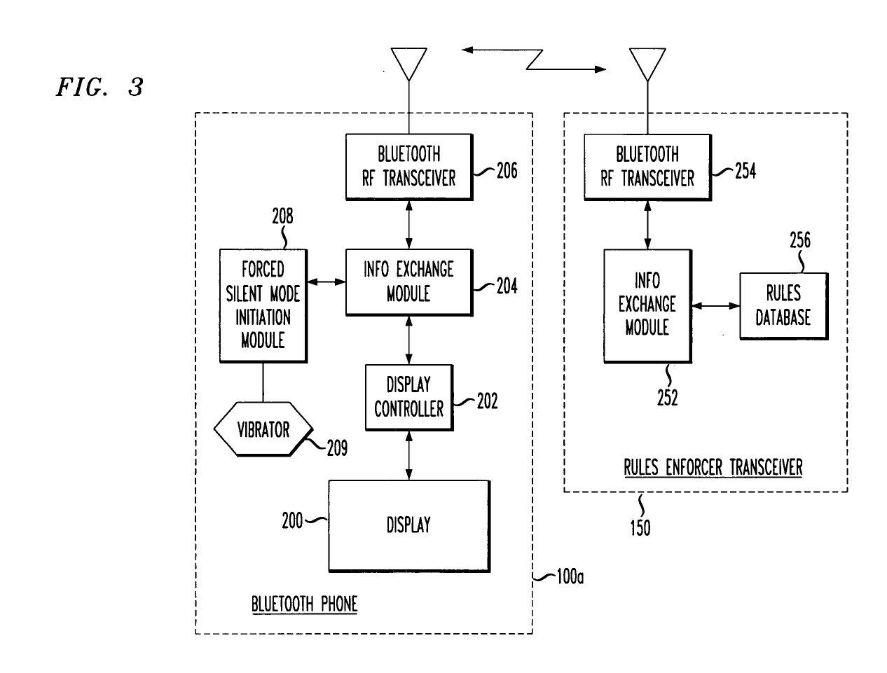

FIG. 3 shows relevant portions of a BLUETOOTH™ enabled phone and a Rules Enforcer Transceiver, shown in FIG. 1.

In particular, as shown in FIG. 3, a rules enforcer 150 includes a wireless transceiver to establish a link with the relevant wireless device, e.g., BLUETOOTH™ RF transceiver 254. An information exchange module 252 obtains relevant rules from a rules database 256, and communicates the same via the appropriate protocol (e.g., BLUETOOTH™) to the relevant wireless device.

Also shown in FIG. 3, the receiving wireless device, e.g. a BLUETOOTH™ enabled phone 100a includes a wireless transceiver 206, a matching information exchange module 204, and an application or module 208 that implements the particular rule that had been received. For instance, if instructed to enter a silent mode, a forced silent mode initiation module 208 may be activated by the information exchange module 204 to disable any audible ringing, etc., and to enable silent operation using devices such as a vibrator 209.

The rules receiver receives the site and user specific rules, then appropriately disables certain features of the wireless device (e.g., disables audible ringing, disables use of the camera, etc.) The particular rule or set of usage ‘rules’ for the various features of an affected BLUETOOTH™ enabled device (e.g., a BLUETOOTH™ capable cell phone) are developed based on the particular features offered.

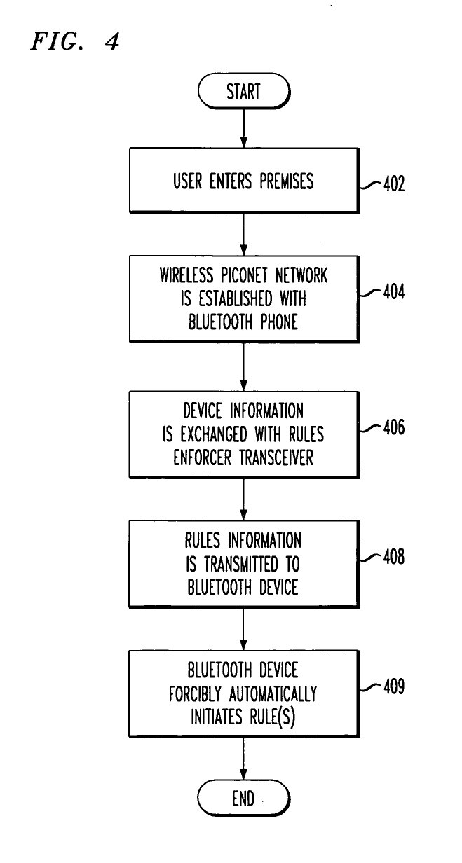

FIG. 4 shows an exemplary flow diagram of a Rules Enforcer Transceiver providing rules information to a BLUETOOTH™ enabled device such as a phone, PDA, etc., in accordance with the principles of the present invention.

In particular, as shown in step 402 of FIG. 4, a user of a wireless device enters a premises, location, airplane, etc. that is covered within the range of a rules enforcer transceiver 150.

In step 404, a link is established between the wireless device and the rules enforcer transceiver 150, a BLUETOOTH™ piconet in the given example but not limited to Bluetooth™.

In step 406, device information is optionally exchanged with the rules enforcer transceiver such that the device type can be determined (e.g., whether the wireless device is a cell phone, PDA, pager, Smartphone, etc.)

In step 408, the rules enforcer transceiver 150 obtains the relevant rules to the type device, preferably combines the same into consistent rules, and then transmits the rule(s) to the wireless device.

In step 409, having received one or more rules from the rules enforcer transceiver 150, the instructions of the received rules are automatically, forcibly carried out, whether or not the user of the wireless device agrees.

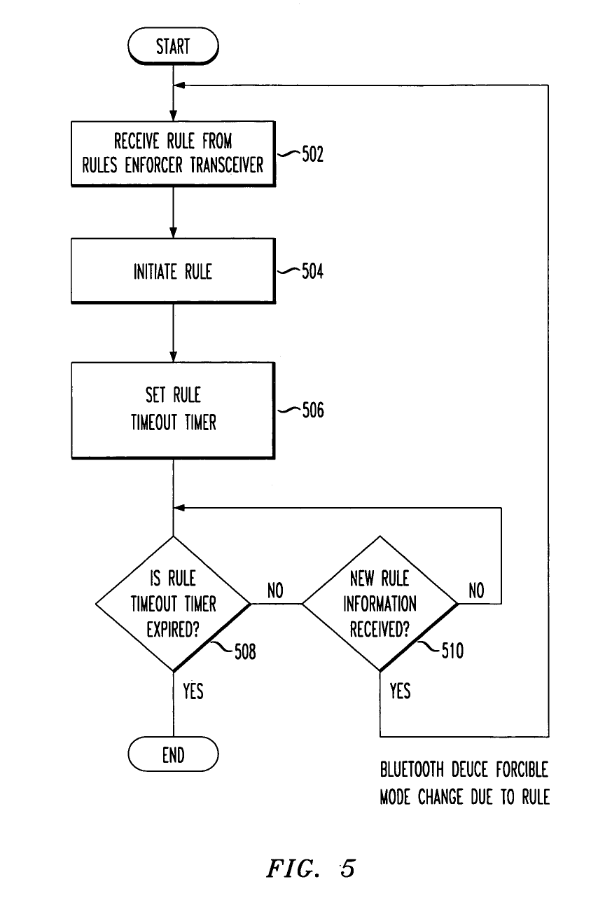

FIG. 5 shows an exemplary flow diagram of a BLUETOOTH™ enabled device having a mode forcibly changed due to reception of an appropriate rule from a Rules Enforcer Transceiver, in accordance with the principles of the present invention.

In particular, as shown in FIG. 5, as shown in step 502, one or more rules is received from the rules enforcer transceiver 150.

In step 504, upon receipt of the rule(s), the receiving wireless device 100 automatically initiates the requested action. While the wireless device 100 may warn of the impending action using, e.g., a display, the user of the wireless device is preferably not allowed to override the particular action, perhaps with the exception of allowing the user to manually power down the wireless device.

In one embodiment, the presence of a ‘rules’ signal and a base station causes the handset to operate based on the given site specific rules. In the absence of a rules signal, the wireless handset (e.g., cell phone) will resume normal operation.

Thus, preferably, a repeated transmission of the rules from the rules enforcer transceiver 150 may allow affected wireless devices to automatically recover from the forcible action after a given time out. As one example of a technique to implement this scenario, as shown in step 506, a rule timeout timer may be set.

In step 508, the timer is monitored to determine if the rule timeout timer has expired.

In step 510, the wireless device looks for retransmission of the relevant rule. If no retransmission is available, then the wireless device may be allowed to re-enter unrestricted use within the premises.

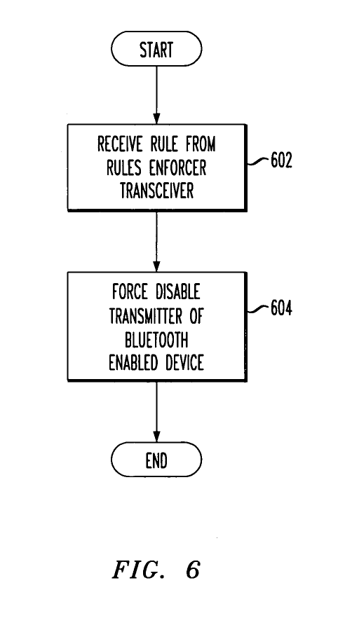

FIG. 6 shows an exemplary flow diagram of a BLUETOOTH™ enabled device being forcibly powered down due to reception of an appropriate rule from a Rules Enforcer Transceiver, in accordance with the principles of the present invention.

In particular, as shown in step 602 of FIG. 6, a rule is received from the rules enforcer transceiver 150.

In step 604, a power down is automatically (i.e., forcibly) initiated in the relevant wireless device, e.g., in a BLUETOOTH™ enabled device.

While disclosed and described with respect to wireless devices in general, and BLUETOOH™ capable cell phones, personal digital assistants (PDAs), pagers and email devices in particular, the present invention has applicability to many other portable electronic devices. Also, while BLUETOOTH™ piconet protocol is described, other short range wireless protocols may be used as the rules transmission mechanism, e.g., ZIGBEE™.

While the invention has been described with reference to the exemplary preferred embodiments thereof, those skilled in the art will be able to make various modifications to the described embodiments of the invention without departing from the true spirit and scope of the invention.

What is claimed is:

1. A communications protocol for enforcing usage rules upon a wireless device, comprising:
establishing at least one rule relating to an action to be forcibly initiated by said wireless device; and
wirelessly transmitting said at least one rule to said wireless device when said wireless device enters a physical area to which said usage rule applies;
wherein said at least one rule relates to an operational parameter of said wireless device without allowing a user of said wireless device to override said at least one rule.

2. The communications protocol for enforcing usage rules of a wireless device according to claim 1, wherein:
said usage rule is a forcible power down of said wireless device.

3. The communications protocol for enforcing usage rules of a wireless device according to claim 1, wherein:
said usage rule is a forcible change of mode of said wireless device.

4. The communications protocol for enforcing usage rules of a wireless device according to claim 3, wherein:
said forcible change of mode is initiation of a silent mode of said wireless device.

5. The communications protocol for enforcing usage rules of a wireless device according to claim 1, wherein:
said wireless device is a cell phone.

6. The communications protocol for enforcing usage rules of a wireless device according to claim 1, wherein:
said wireless device is a personal digital assistant (PDA).

7. The communications protocol for enforcing usage rules of a wireless device according to claim 1, wherein:
said wireless device is an email device.

8. The communications protocol for enforcing usage rules of a wireless device according to claim 1, wherein:
said wireless transmission is transmitted over an established piconet network.

9. The communications protocol for enforcing usage rules of a wireless device according to claim 8, wherein:
said established piconet network conforms to BLUETOOTH™ standards.

10. A method of implementing a mandatory usage rule for operation of a wireless device, comprising:
establishing a wireless link to receive at least one rule relating to operation of at least one feature of said wireless device when said wireless device enters a physical area to which said usage rule applies; and
automatically implementing an instruction contained by said at least one rule in said wireless device;
wherein said at least one rule relates to an operational parameter of said wireless device without allowing a user of said wireless device to override said at least one rule.

11. The method of enforcing usage rules of a wireless device according to claim 10, wherein:
said usage rule is a forcible power down of said wireless device.

12. The method of enforcing usage rules of a wireless device according to claim 10, wherein:
said usage rule is a forcible change of mode of said wireless device.

13. The method of enforcing usage rules of a wireless device according to claim 12, wherein:
said forcible change of mode is initiation of a silent mode of said wireless device.

14. The method of enforcing usage rules of a wireless device according to claim 10, wherein:
said wireless device is a cell phone.

15. The method of enforcing usage rules of a wireless device according to claim 10, wherein:
said wireless device is a personal digital assistant (PDA).

16. The method of enforcing usage rules of a wireless device according to claim 10, wherein:
said wireless device is an email device.

17. The method of enforcing usage rules of a wireless device according to claim 10, wherein:
said wireless link is a piconet network.

18. The method of enforcing usage rules of a wireless device according to claim 17, wherein:
said piconet network conforms to BLUETOOTH™ standards.

19. Apparatus for enforcing usage rules of a wireless device, comprising:
means for establishing at least one rule relating to an action to be forcibly initiated by said wireless device; and
means for wirelessly transmitting said at least one rule to said wireless device when said wireless device enters a physical area to which said usage rule applies;
wherein said at least one rule relates to an operational parameter of said wireless device without allowing a user of said wireless device to override said at least one rule.

20. Apparatus for implementing a mandatory usage rule for operation of a wireless device, comprising:
means for establishing a wireless link to receive at least one rule relating to operation of at least one feature of said wireless device when said wireless device enters a physical area to which said usage rule applies; and
means for automatically implementing an instruction contained by said at least one rule in said wireless device;
wherein said at least one rule relates to an operational parameter of said wireless device without allowing a user of said wireless device to override said at least one rule.
